(19) United States
(12) Patent Application Publication
(10) Pub. No.: US 2011/0111861 A1
(43) Pub. Date: May 12, 2011

(54) GAMING DEVICE ARCHITECTURE AND RELATED COMPONENTS

(75) Inventors: Andrew St. Martin, Las Vegas, NV (US); Sreekanth Iyer, Las Vegas, NV (US); Robert W. Crowder, JR., Las Vegas, NV (US); James Lawrence, Henderson, NV (US)

(73) Assignee: BALLY GAMING, INC., Las Vegas, NV (US)

(21) Appl. No.: 12/828,206

(22) Filed: Jun. 30, 2010

Related U.S. Application Data
(60) Provisional application No. 61/260,753, filed on Nov. 12, 2009.

(51) Int. Cl. A63F 9/24; A63F 13/00

(52) U.S. Cl. 463/42; 463/35

(57) ABSTRACT

A gaming platform for a gaming machine includes a game application having non-shared, executable game objects and game specific information. The game application comprises at least one game manager interface, at least one library routine for receiving commands from the game manager and sending commands to gaming machine drivers, and at least one I/O server comprising a plurality of gaming machine hardware drivers. The gaming platform also includes an operating system having an operating system application and data that are used to provide a plurality of general gaming features, wherein the operating system runs the game application and executes general gaming features in response to requests from the game application. The gaming platform further includes a testing manager in communication with the game manager, wherein the testing manager communicates with an external test client to determine operability of one or more components within the gaming machine. In this embodiment, the game manager interface receives an I/O stream to the game application and communicates with at least one of the library routine, the I/O server, and the operating system to facilitate game application functions.

### CROSS-REFERENCE TO RELATED APPLICATIONS

This application claims the benefit of U.S. Provisional Application No. 61/260,753, filed Nov. 12, 2009, which is herein incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Over the years, gaming machines have grown in both sophistication and gaming features to maintain player interest. Gaming machines have gone from relatively simple devices providing a player with an opportunity to win cash awards to sophisticated, multi-media devices. Even more, the games presented on the gaming machines have become increasing intricate. For example, slot-style games include may include five or more reels with twenty or more paylines. Furthermore, games may include one or more bonus games or different game modes that allow a player to participate in a community game or a tournament. Accordingly, with the increasing complexity of these games, there is a continuing need for gaming machines to have the capabilities to support increasingly, complex games.

### SUMMARY

Briefly, and in general terms, various embodiments are directed to a gaming platform having a processor board and a gaming kernel that provides an application program interface (API) to a game application. In one embodiment the gaming platform includes a game media having executable game code, game-specific information relating to a game application, and an operating system media having executable programs and data used for general gaming features. The game media and the operating system media are separated so that changes to either media does not affect the other.

In one embodiment, a gaming platform for a gaming machine includes a game application having non-shared, executable game objects and game specific information. The game application comprises at least one game manager interface, at least one library routine for receiving commands from the game manager and sending commands to gaming machine drivers, and at least one I/O server comprising a plurality of gaming machine hardware drivers. The gaming platform also includes an operating system including an operating system application and data that are used to provide a plurality of general gaming features, wherein the operating system runs the game application and executes general gaming features in response to requests from the game application. The gaming platform further includes a testing manager in communication with the game manager, wherein the testing manager communicates with an external test client to determine operability of one or more components within the gaming machine. In this embodiment, the game manager interface receives an I/O stream to the game application and communicates with at least one of the library routine, the I/O server, and the operating system to facilitate game application functions.

In another embodiment, the gaming platform for a gaming machine includes an operating system program including data for basic core functions of a gaming machine, and a game application program including game-specific non-shared executable objects, paytable data, graphics, and sounds. In this embodiment, the game application program is separate from the operating system program, and the game application program drives the operation of a game. The gaming platform also includes a testing program in communication with the game manager, wherein the testing program communicates with an external test client to determine operability of one or more components within the gaming machine. The gaming platform further includes a game manager interface in communication with the game application program and the operating system program, wherein the game manager interface facilitates the functions called by the game application program and carried out by the operating system program.

Other features and advantages will become apparent from the following detailed description, taken in conjunction with the accompanying drawings, which illustrate by way of example, the features of the various embodiments.

### BRIEF DESCRIPTION OF THE DRAWING

FIG. 1 is a functional block diagram showing a game kernel according to one embodiment of a gaming device.

FIG. 2 is a block diagram illustrating an embodiment of a platform architecture for one embodiment of a gaming device.

FIG. 3 is a block diagram of the components for an automated testing system.

FIG. 4 illustrates one embodiment of a packet structure used in an automated testing system.

FIG. 5 illustrates one embodiment of a gaming device.

FIG. 6 illustrates one embodiment of a gaming system network including the gaming device of FIG. 5.

### DETAILED DESCRIPTION

Various embodiments are directed to a gaming device having an enhanced gaming platform that provides additional functionality to the gaming device. The enhanced gaming platform provides for easy hardware and software upgrades. According to one embodiment, the gaming platform includes processor board and a gaming kernel which, by providing a callable, consistent user-interface API to the hardware and permits minimal game programming changes for game-level programmers after hardware changes. The game kernel also provides backward compatibility, thereby allowing hardware upgrades without requiring immediate game software updates. In another embodiment, the gaming device has a gaming platform as disclosed in U.S. patent application Ser. No. 10/794,760, which is herein incorporated by reference in its entirety.

According to one embodiment, the processor board is mounted inside the gaming device using physical board mounts (e.g., slides, guides, or rails). In another embodiment, the I/O board is a separate component that is connected to the processor board. In one embodiment, the processor board may be an Intel Celeron processor or other processor boards known or developed in the art. In one embodiment, the processor board includes input/output (I/O) ports, pins, plugs, connectors, opto-isolators, connector blocks, bus connectors, or any other connections that enables a device or component within the gaming cabinet to be functionally connected to the processor board.

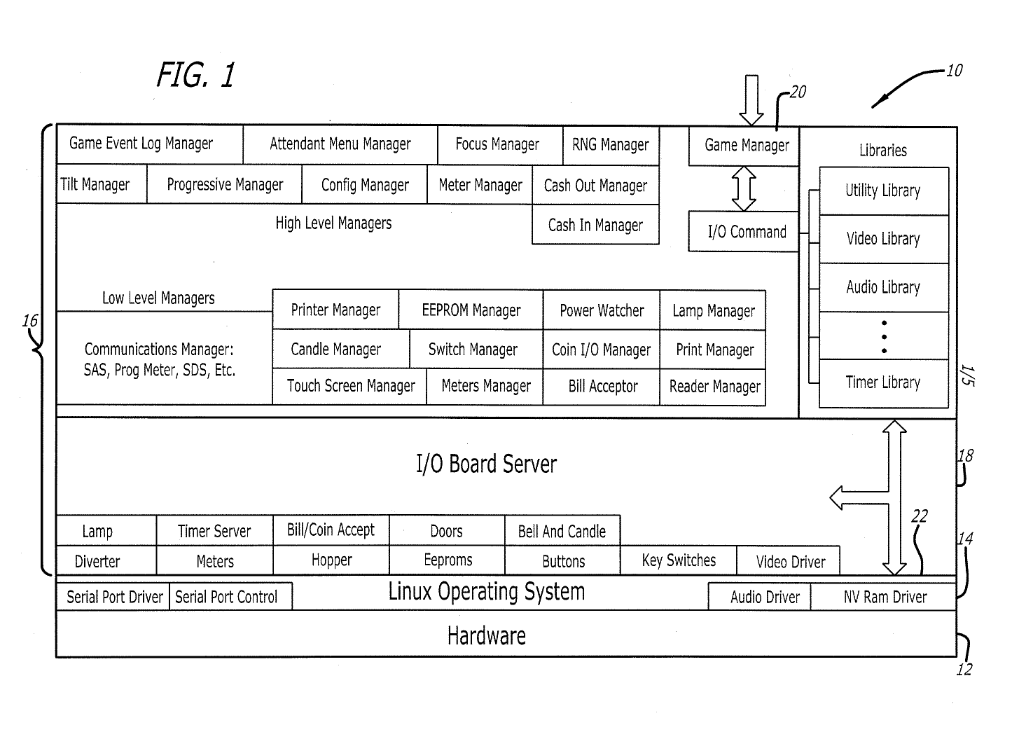

FIG. 1 illustrates one embodiment of the gaming platform 10 having three layers: (1) the hardware layer 32; (2) the operating system14; and (3) the game kernel layer 16. The game kernel includes a component labelled as an I/O Board Server 18. Ordinarily, the software contained in the I/O Board Server 18 is embodied as drivers and controllers within the game kernel 16 in order to minimize performance and security problems. However, in the embodiment of the gaming platform 10 shown in FIG. 1, the functions of the I/O Board Server 18 are brought to the user level without any performance and security problems. To properly set the bounds of the game application software, all game applications interact with the game kernel 18 using a single application programming interface (API) in the game manager. This enables game applications to make use of a well-defined, consistent interface as well as making access points to the gaming kernel controlled, wherein overall access is controlled using separate processes.

When the game manager 20 parses an incoming message stream and sends it to the applicable library routine. The library routine then determines what is needed from a device, and the library routine sends commands to the I/O Board Server 18. As shown in FIG. 1, a few drivers are located within the operating system kernel (below line 22). These drivers are built-in, primitive, or privileged drivers that are general, kept to a minimum, and are easier to leave in the operating system kernel rather than extract to the user level. In such cases, the low-level communications are handled within the operating system, and the contents are passed to the library routines.

Regardless of the path taken, the software or other “smarts” needed to work with each device is coded into modules in the user layer 16 (e.g., game kernel layer) as shown in FIG. 1. Accordingly, the operating system 14 is kept as simple and stripped down so that operating system runs across as many platforms as possible. The library utilities and the user-level drivers are customized for the particular gaming device. Accordingly, the game kernel includes gaming device-unique library routines and I/O Board Server components needed to enable game applications to interact with the gaming device (or components in the game cabinet).

As shown in FIG. 1, the gaming kernel 16 includes a game manager 26. The game manager 20 provides the interface to the game kernel 16 that is consistent, predictable, and backwards compatible calling methods, syntax, and capabilities (game application API). This enables the game developer to be free of dealing directly with the hardware, including the freedom to not have to deal with low-level drivers as well as the freedom to not have to program lower level managers (although lower level managers may be accessible through the Game Manager's interface if a programmer has the need). In addition, the game manager 20 provides access to a set of upper level managers that also provides consistent callable, object oriented interfaces and further provides the types and kinds of base functionality required in all casino-type games.

The Game Manager 20 has several objects within itself, including an Initialization object. The Initialization object performs the initialization of the entire game machine, including other objects, after the game manager 20 has started its internal objects and servers in appropriated order. In order to carry out this function, the Configuration Manager is amongst the first objects to be started. The Configuration manager has data needed to initialize (correctly configure) other objects or servers.

After the game is brought up (initialized) into a known state, the Game Manager 20 checks the configuration and then brings either a game or a menu object. The game or menu object completes the setup required for the application to function, including but not limited to, setting up needed callbacks for events that are handled by the event manager, after which control is passed back to the Game Manager. The Game Manager 20 now calls the game application to start running; and the game machine is made available for player use.

While the game application is running (typically during game play), the application continues to make use of the Game Manager. In addition to making function calls to invoke functionality found in the game kernel, the application will receive, using the callbacks set up during initialization and configuration, event notification and related data. Callback functionality is suspending if an internal error occurs (“Tilt event”) or if a call attendant mode is entered. When this state is cleared, event flow continues.

In a multi-game or menu-driven environment, the event callbacks set by a game application during its initialization are typically cleared between applications. The next application, as part of its initialization sequence, sets any needed callbacks. This would occur, for example, when a player ends one game, invokes a menu (callbacks cleared and reset), then invokes a different game (callbacks cleared and reset).

Additionally, the game kernel 16 also includes high level and low level managers as shown in FIG. 1. For example, the Game Event Log Manager provides, at a minimum, a logging or logger base class that enables other logging objects to be derived from this base object. The logger (or logger object) is a generic logger. That is, the logger is not aware of the contents of logged messages and events. The Log Manager's job is to log events in NVRAM event log space. The size of the space if fixed, although the size of the logged event is not. When the event space or log space fills up, one embodiment of the Log Manager will delete the oldest logged event (each logged event will have a time/date stamp, as well as other needed information such as length), thereby providing space to record the new event. In this embodiment, the latest events will be found in NVRAM log space, regardless of their relative importance. The Log Manager is further provided with the capability to read the stored logs for event review.

The Meter Manager manages the various meters embodied in the game kernel. This includes the accounting information for the game machine and game play. There are hard meters (counters) and soft meters; the soft meters are stored in NVRAM to prevent loss. Further, a backup copy of the soft meters is stored in EEPROM. In one embodiment, the Meter Manager receives its initialization data for the meters, from the Configuration (Config) Manager during startup. While running, the Cash In and Cash Out Managers call the Meter Manager's update functions to update the meters, and the Meter Manager will, on occasion, create backup copies of the soft meters by storing the soft meters readings in EEPROM. This is accomplished by calling and using the EEPROM Manager.

The Progressive Manager manages progressive games playable from the game machine. It receives a list of progressive links and options from the Config Manager on startup. The Progressive Manager further registers progressive event codes (“events”) and associated callback functions with the Event Manager to enable the proper handling of progressive events during game play. The Progressive Manager may further involve other components such as the Comm Manager, the Meters Manager, and any other associated or needed modules, and/or upper or lower level managers. This enables the game application to make use of progressives known to the game machine via the network in the casino. The progressives may be local to the casino or may extend beyond the casino.

The Event Manager object is a generic object that handles events but does not have any knowledge of the meaning of events. Each event contains fields as needed for event management, including as needed and designed, a date/time stamp, length field, an event code, and event contents. The Event Manager is driven by its users; because the Event Manager records events as passed to it by other processes. The Event Manager uses its callback lists so that any process known to the Event Manager and having registered a callback event number that matches the event number given to the Event Manager by the event origination process will be signalled (“called”).

The Focus Manager object correlates which process has control of which focus items. During game play, objects can request a focus event, and provide a callback function with the call. This includes the ability to specify lost focus and regained focus events. In one embodiment, the Focus Manager uses a FIFO list when prioritizing which calling process gets their callback functions handled relating to a specific focus item.

The Tilt Manager is an object that receives a list of errors (if any) from the Configuration Manager at initialization and from processes, managers, and/or drivers that generate errors during play. The Tilt Manager watches the overall state of the game. If a condition or set of conditions occur, a tilt message is sent to the game application. The game application then suspends play, resumes play, or otherwise responds to the tilt message as needed.

The Random Number Generator (RNG) Manager is provided to allow easy programming access to an RNG. The RNG Manager includes the capability of using multiple seeds by reading RNG seeds from NVRAM. The seeds can be updated/changed as required in those jurisdictions that require periodic seed updates. In another embodiment, the RNG manager is able to generate random numbers using a single seed. The RNG manager and the RNG having a single seed are discussed below.

The Credit Manager object manages the current state of credits (cash value or cash equivalent) in the game machine. The Cash In and Cash Out objects are the only objects that have read privileges into the Credit Manager. All other objects only have read capability into the public fields of the Credit Manager. The Credit Manager keeps the current state of the credits available, including any available winnings, and further provides denomination conversion services.

The Cash Out Manager has the responsibility of configuring and managing monetary output devices. During initialization, the Cash Out Manager, using data from the Configuration Manager, sets the cash out devices correctly and selects any selectable cash out denominations. During play, a game application may post a cash out event through the Event Manager, and using the callback posted by the Cash Out Manager, the Cash Out Manager is informed of the event. The Cash Out Manager updates the Credit Object, updates its state in NVRAM, and sends an appropriate control message to the device manager that corresponds to the dispensing device. As the device dispenses dispensable media (e.g., vouchers), there will typically be event messages being sent back and forth between the device and the Cash Out Manager until the dispensing finishes. Once completed, the Cash Out Manager, having updated the Credit Manager and any other game state (such as some associated with the Meter Manager) that needs to be updated for this set of actions, sends a cash out completion event to the Event Manager and to the game application thereby.

The Cash In Manager functions similarly to the Cash Out Manager. The Cash In Manager only controls, interfaces with, and takes care of actions associated with cashing in events, cash in devices, and associated meters and crediting.

In one embodiment, a platform is provided which separates the game media from the operating system (OS) media. The OS media in the platform contains all executable programs and data that drive the core gaming features. This includes, but is not limited to, hardware control, communications to peripherals, communications to external systems, accounting, money control, etc. The game media contains all executable game code, paytable data, graphics, sounds and other game specific information to run the particular game application or program. The game program communicates with the OS programs to perform core gaming features as required. This method to facilitate communications between the game media and the OS media will be further described below.

Because the game program and all of its game specific data are stored in a separate media, the game media can be updated independently from the OS media. This allows programmers to develop completely new games and respective game media that can be used with old OS media or new OS media. Programmers can also add features to the OS media or fix bugs in the core features by simply releasing a new OS media. As new features are added to the OS media, the GPI may be kept backward compatible with older game media released in the field. This allows the ability for feature growth in the OS without having to maintain or re-release hundreds of game programs already developed, tested, and approved by the regulatory agencies.

The following further describes the Game Manager Interface used in the platform. The Game Manager Interface is used by the game application to perform the game machine functions on the platform. In this manner, the game application is not concerned with any game machine functions and is game machine independent. This independence allows a game application to run on various platforms with various device configurations without modification.

In one implementation, the platform is designed and implemented using object oriented techniques. The game manager interface is generic and can handle various styles of games. Each different game will use the same game manager interface. Due to this design, a game base class is implemented. The game base class is contained in game.cpp and game.h. The game base class Init function creates the game manager interface, initializes the game manager interface, and registers for the callbacks. Each callback calls a game object member function.

A game application (such as slot or poker) can be derived from the game base class. This derived game object can override the base class member functions, which are being called by the callbacks. In this manner, the game programmer can take advantage of the game manager interface code that exists in the game base class.

To continue with this method, a specific game can be derived from the game type object (such as slot or poker). Again, this specific game object can override the game type object member functions. This method allows the game programmer to concentrate on programming the graphics and sounds for the new specific game, and not redevelop the code required to interface with the game manager.

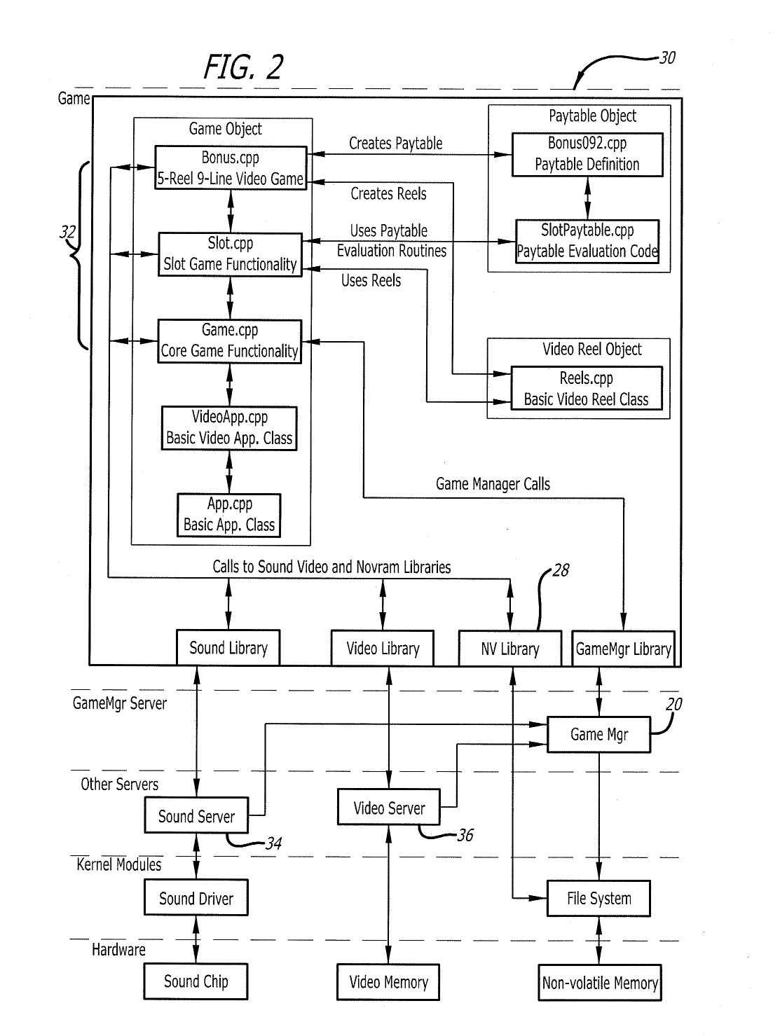

FIG. 2 is a simplified block diagram illustrating an embodiment of the platform architecture 30 having five (5) layers. The top layer is the game application 32. This application is responsible for the game play functionality. The GameMgr 20 is a separate application which manages the basic functionality for gaming machines, hopper pays, tilts, communications, accounting, diagnostics, or the like. The Sound and Video Servers 34,36 provide multimedia capability to both the game 32 and GameMgr 20 applications. Both the game and GameMgr use the Non-volatile library (NV Library 38) to store critical data and state information using the Linux file system.

In one embodiment, the gaming platform includes an I/O system having an I/O shell, a number of subsystems and associated configuration files. This system communicates to the rest of the platform via a generic application programming interface (API). One implementation uses inter-process communications. The platform I/O architecture has been designed to be modular, flexible, extensible and configurable. This allows the platform to research its maximum potential across a multitude of hardware systems because the platform may be converted to different game cabinets and/or unique sets of I/O devices without major changes.

The gaming platform includes an automated testing (AT) system. The AT system includes an external test client (e.g., Windows-based or Linux-based PCs), a debug BIOS, and the software for testing various components within a gaming device. The AT system includes an AT client library that provides a foundation to build customizable applets in a variety of common programming languages for various tests. In one embodiment, the AT system's test architecture handles all of low level communications between the game platform and the external test client.

Generally, Command-Response messages are passed from an AT Client Manager (AT Client) to the AT Manager using TCP/IP as a transport. The messages specify a command and include any parameters needed for the command. The AT Manager responds with a message including a status (success/failure) and data associated with the command. In addition, the AT Client registers for certain events. When an event occurs on the gaming device, the AT Manager sends a message to the AT Client that includes the event just occurred and any data associated with the event.

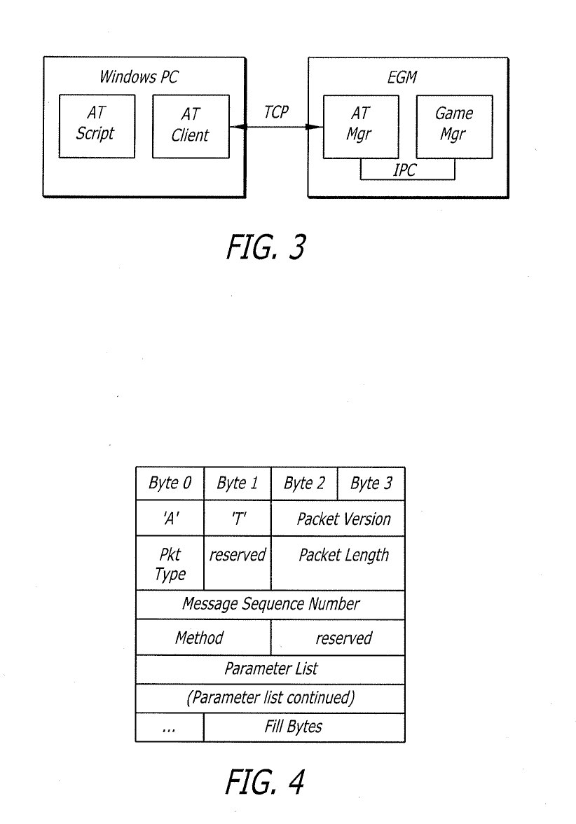

FIG. 3 shows the components of one embodiment of the AT architecture. An external PC (e.g., a Windows or Linux PC) runs an AT Script that uses the AT Client to transmit AT commands to the EGM over a TCP socket. The AT Manager on the gaming device forwards these AT commands via IPC to processes on the gaming device (e.g., the Game Manager). The AT Script in the external PC also registers gaming device events. As a result, when an event occurs on the gaming device, the AT Manager receives notice of the event via IPC and sends an event message to the AT Client.

The AT Manager shown in FIG. 3 is a module that runs on the gaming device. The AT Manager is event-driven and does not initiate any actions on its own. The AT Manager triggers the actions as instructed by the AT Client and reports the results to the AT Client. That is, the AT Manager redirects incoming TCP messages to the appropriate IPC client without needing to know the command details or its response. The AT Manager also redirects Event Messages to the AT clients that are registered to receive Events.

The AT Manager executes two execution threads. The first thread processes incoming TCP commands from the AT Clients (located on an external device) and queues the commands for transmission to the IPC clients in the gaming device. The second thread processes responses from the Game Manager (i.e., IPC clients) and queues them for transmission to the AT Clients. As shown in FIG. 3, IPC calls are used to communicate between the AT Manager and the Game Manager.

The AT Client provided on an external PC includes a library for creating scripts to obtain information from the gaming device. Scripting languages that implement AT scripts include, but are not limited to, Python, Perl, and Ruby. In one embodiment, Python is used as the AT script language due to its powerful, simple, and clear syntax. Additionally, Python allows for the creation of an easy-to-use interface for remove procedure calls.

In operation, when the AT Manager receives a Command Message from the AT Client, the AT Manager verifies that the Command Message is complete and correctly formatted. Additionally, the AT Manager reviews the Method String in the Command Message and sends an IPC message to an AT Worker (GameMgr) on the gaming device that is registered for the Method. If the AT Worker responds, the response data is encapsulated and sent back to the AT Client.

For example, when an AT Manager receives a GetMeter message, it reads the Method Code to determine which method is requested and which AT Worker is appropriate to process the command. The AT Manager forwards an IPC request to the AT Worker registered for GetMeter and includes a parameter list for requested meters. The AT Worker parses the parameter list to determine which meter is requested and sends the current meter value to AT Manager via IPC. The AT Manager encapsulates the response (i.e., the current meter value) and sends the response back to the AT Client. Additionally, when the AT Manager receives an Event for which an AT Client has registered, the Event information is encapsulated in an Event message by the AT module, and the Event message is sent to the AT Client.

The Command-Response messages and the Event messages described above are encoded in packets that are easy to encode and decode. These packets reduce the CPU requirements and also simplify development in scripting languages. Thus, the automated test code may be developed in the most expedient language for testing. FIG. 4 illustrates one embodiment of a packet structure used in the AT system.

As shown in FIG. 4, the Command-Response messages transmitted between the AT Client and the AT Manager begin with a standard header that includes a two-byte signature, a 2-byte Packet Version, a Packet Type field, a Packet Length field, a Message Sequence Number, and a Method number. The Packet Type is a one-byte field containing: ‘C’ for a command packet, ‘R’ for a response packet, or ‘E’ for an event packet. A reserved byte follows the Packet Type field in which the reserved bytes are filled with NULL bytes.

The Packet Length field follows the reserved bytes field. The Packet Length field is a 2-byte binary number (little endian) for the number of bytes following the packet length field. The maximum packet length is 2″-16. In one embodiment, all packets will be a multiple of 4 bytes, and the packet fields are padded with NULL fill bytes, if necessary.

After the Packet Length field, a 4-byte Message Sequence Number is specified. Command requests insert an identifying sequence number in the field. The Response to this Command also includes the same Message Sequence Number. In this way, multiple commands can be sent to the gaming device and allow responses for outstanding commands to be identified.

Following the Message Sequence Number Field, the Method number field is a remote procedure to invoke. In one embodiment, numerical codes may be used to represent methods. In another embodiment, method strings are used to identify a particular method. A fully qualified method string includes a Module Name followed by a Method Name. For example, when an AT Module named “MeterMgr” has a method called “GetMeter,” the AT Client refers to the method as “MeterMgr.GetMeter”.

The Parameter List shown in FIG. 4 includes the data needed by the remote procedure. The Parameter List field is formatted similarly to shell programs that pass parameters to commands. In on embodiment, the Parameter lists are encoded in ASCII (or UTF8) as space-separated byte streams with white space separating each parameter. A parameter is a sequence of non-space characters or a quoted string. Strings may be enclosed with either single (′) or double quotes (″). If a string is enclosed within double quotes, the single quote character has no special meaning. If enclosed within single quotes, the double quote character has no special meaning. Within a quoted string, a quote character is included by preceding it with a backslash (\). Within a quoted string, one backslash is included by preceding it with a backslash (\\). Event packets are like Command/Response packets. The Packet Type is ‘E’, the Method number field contains the event code. The first parameter of an Event packet is a time stamp of when an event occurred on the EGM.

The AT System is capable of testing low-level features as well as high-level features. Low level features that may be tested include, but are not limited to, the following: NVRAM clear, meter read, simulate money in (bill and/or coin), simulate deck button input, report game play event, pay table testing, Report Event (any event logged by the gaming device), simulate touch screen events, simulate voucher in, or report low-level outputs such as, but not limited to, candle flashing or door open. High level features that may be tested include, but are not limited to, the following: read and store Bally's Alpha Gaming Platform configuration; load a stored Bally's Alpha Gaming Platform Debug support including, but not limited to, breakpoint, read memory, or set memory; log serial output; paytable testing; or power cycle testing.

With respect to “Report Event” testing, a typical Game Manager uses approximately 600 event codes. While the AT Module registers handlers for these event codes, there are particular events that are logged by the Log Manager that may garner additional testing because those events generally signify an important event has occurred on the gaming device. These events are stored on the NVRAM and are generally accessed by an operator in the “History” screens. In one embodiment, two operation modes are implemented for displaying “Logged Events.” In a first mode, the AT Client registers to receive an event (or class of events). As these events are generated on the gaming device, messages are sent to the AT Client. In a second mode, the AT Client registers to receive logged events stored in NVRAM. For example, an AT Client script may ask for “dump” of GameEvent History. In other embodiments, either mode of operation may be implemented for displaying “Logged Events.”

In one embodiment, Event data is stored in a binary format on the gaming device. To minimize the load on the gaming device, AT messages are transmitted in the binary format, and the external PC can decode the data. As a result, there is a tight coupling the version of the Event data with the version of PC client. Optionally, the Event data version may be decoupled from the Event data version from PC client. The Event data is then decoded to a “string” on the gaming machine-side. By way of example and not by way of limitation, the following GameMgr event classes are implemented: Event; Game Event; Progressive Win; and Transactions such as, but not limited to, Bill In, Cash Out, Hand Pay, or Voucher.

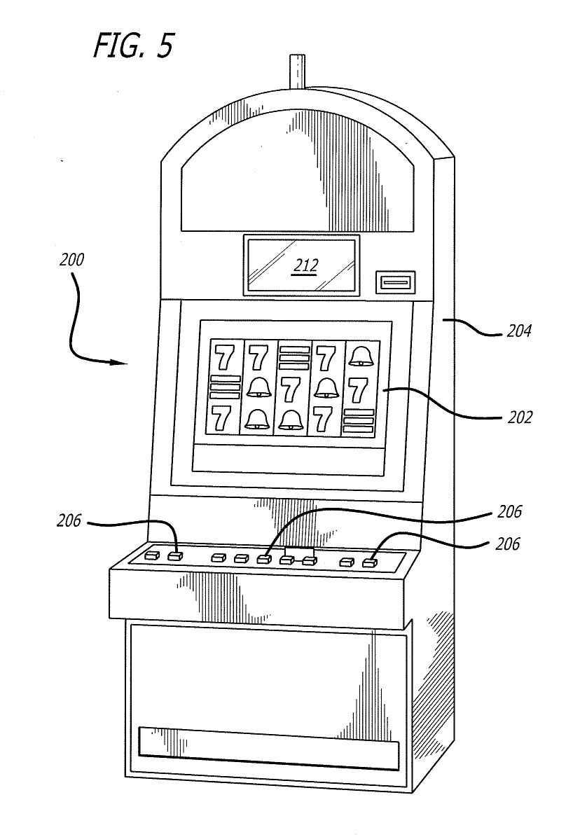

FIG. 5 illustrates one embodiment of a gaming device including one or more of the following: an enhanced number generator, protocol extensions for 2-D barcode vouchers, NTP, Alpha sockets, Automated testing, or is a member of a Network Group. As shown in FIG. 5, the main cabinet 204 of the gaming machine 200 is a self-standing unit that is generally rectangular in shape. In another embodiment, the main cabinet 204 may be a slant-top gaming cabinet. Alternatively, in other embodiments, the gaming cabinet may be any shaped cabinet known or developed in the art that may include a top box. Additionally, the cabinet may be manufactured with reinforced steel or other rigid materials that are resistant to tampering and vandalism. Optionally, in an alternate embodiment, the gaming machine 200 may instead be a cinema-style gaming machine (not shown) having a widescreen display, as disclosed in U.S. application Ser. No. 11/225,827, entitled “Ergonomic Gaming Cabinet,” filed on Sep. 12, 2005, which is hereby incorporated by reference.

As shown in FIG. 5, the gaming machine 200 includes a main display 202. According to one embodiment, the main display 202 is a plurality of mechanical reels for presenting a slot-style game. Alternatively, the main display 202 is a video display for presenting one or more games such as, but not limited to, mechanical slots, video slots, video keno, video poker, video blackjack, video roulette, Class II bingo, games of skill, games of chance involving some player skill, or any combination thereof.

According to one embodiment, the main display 202 is a widescreen display (e.g., 16:9 or 16:10 aspect ratio display). In one embodiment, the display 202 is a flat panel display including by way of example only, and not by way of limitation, liquid crystal, plasma, electroluminescent, vacuum fluorescent, field emission, LCOS (liquid crystal on silicon), and SXRD (Silicon Xtal Reflective display), or any other type of panel display known or developed in the art. These flat panel displays may use panel technologies to provide digital quality images including by way of example only, and not by way of limitation, EDTV, HDTV, or DLP (Digital Light Processing).

According to one embodiment, the widescreen display 202 may be mounted in the gaming cabinet 204 in a portrait or landscape orientation. In another embodiment, the game display 202 may also include a touch screen or touch glass system (not shown). The touch screen system allows a player to input choices without using any electromechanical buttons 206. Alternatively, the touch screen system may be a supplement to the electromechanical buttons 206.

The main cabinet 204 of the gaming machine also houses a game management unit (not shown) that includes a CPU, circuitry, and software for receiving signals from the player-activated buttons 206 and a handle (not shown), operating the games, and transmitting signals to the respective game display 206 and speakers (not shown). Additionally, the gaming machine includes an operating system such as Bally Gaming's Alpha 05, as disclosed in U.S. Pat. No. 7,278,068, which is hereby incorporated by reference.

In various embodiments, game program may be stored in a memory (not shown) comprising a read only memory (ROM), volatile or non-volatile random access memory (RAM), a hard drive or flash memory device or any of several alternative types of single or multiple memory devices or structures.

As shown in FIG. 5, the gaming machine 200 includes a plurality of player-activated buttons 206. These buttons 206 may be used for various functions such as, but not limited to, selecting a wager denomination, selecting a number of games to be played, selecting the wager amount per game, initiating a game, or cashing out money from the gaming machine 200. The buttons 206 function as input mechanisms and may include mechanical buttons, electromechanical buttons or touch screen buttons. In another embodiment, one input mechanism is a universal button module that provides a dynamic button system adaptable for use with various games, as disclosed in U.S. application Ser. No. 11/106,212, entitled “Universal Button Module”, filed Apr. 14, 2005 and U.S. application Ser. No. 11/223,364, entitled “Universal Button Module”, filed Sep. 9, 2005, which are both hereby incorporated by reference. Additionally, other input devices, such as but not limited to, touch pad, track ball, mouse, switches, and toggle switches, are included with the gaming machine to also accept player input. Optionally, a handle (not shown) may be “pulled” by a player to initiate a slots-based game.

One of ordinary skill in the art will appreciate that not all gaming devices will have all these components or may have other components in addition to, or in lieu of, those components mentioned here. Furthermore, while these components are viewed and described separately, various components may be integrated into a single unit in some embodiments.

In some embodiments, the gaming machine 200 is part of a gaming system connected to or with other gaming machines as well as other components such as, but not limited to, a Systems Management Server (SMS) and a loyalty club system (e.g., casino management personnel/system (CMP/CMS)). Typically, the CMS/CMP system performs casino player tracking and collects regular casino floor and player activity data. The gaming system may communicate and/or transfer data between or from the gaming machines 200 and other components (e.g., servers, databases, verification/authentication systems, and/or third party systems).

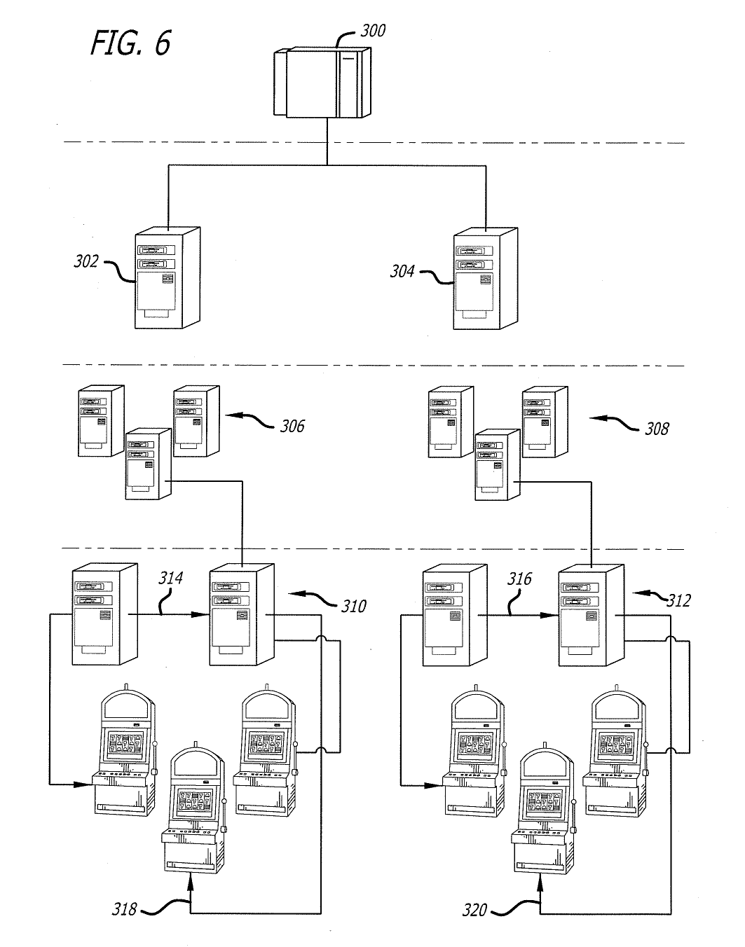

An embodiment of a network that may be used with the system is illustrated in FIG. 6. The example network consists of a top level vender distribution point 300 that contains all packages for all jurisdictions, one or more Jurisdiction distribution points 302 and 304 that contain regulator approved production signed packages used within that jurisdiction or sub-jurisdiction, one or more Software Management Points 306 and 308 to schedule and control the downloading of packages to the gaming machine and a one or more Software Distribution Points 310 and 312 that contain regulator approved production signed packages only used in the gaming establishment that it supports. The Software Distribution Points (SDPs) 310 and 312 can communicate with Systems Management Points (SMPs) 314 and 316, respectively as well as directly to one or more gaming machines 318 and 320. The system allows for rapid and secure distribution of new games, configurations, and OS's from a centralized point. It makes it possible to update and modify existing gaming machines with fixes and updates to programs as well as providing modifications to such files as screen images, video, sound, pay tables and other gaming machine control and support files. It provides complete control of gaming machines from a centralized control and distribution point and can minimize the need and delay of human intervention at the gaming machine. In one embodiment, the configuration control may be from the SDPs 310, 312 or from the gaming servers.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A gaming platform for a gaming machine, comprising:
a game application having non-shared, executable game objects and game specific information, the game application comprising at least one game manager interface, at least one library routine for receiving commands from the game manager and sending commands to gaming machine drivers, and at least one I/O server comprising a plurality of gaming machine hardware drivers;
an operating system including an operating system application and data that are used to provide a plurality of general gaming features, wherein the operating system runs the game application and executes general gaming features in response to requests from the game application; and
a testing manager in communication with the game manager, wherein the testing manager communicates with an external test client to determine operability of one or more components within the gaming machine;
wherein the game manager interface receives an I/O stream to the game application and communicates with at least one of the library routine, the I/O server, and the operating system to facilitate game application functions.

2. The gaming platform of claim 1, further comprising a sound server having sound files that are in communication with the game manager interface, wherein the sound server receives requests for and sends sound files to the game manager interface for execution on the gaming machine.

3. The gaming platform of claim 1, further comprising a video server in communication with the game manager interface, wherein the video server receives requests for and sends graphic files and fonts to the game manager interface for execution on a gaming machine.

4. The gaming platform of claim 1, further comprising a multimedia server having multimedia applications, wherein the multimedia server is in communication with the game manager, and wherein the multimedia server provides multimedia capabilities to the game application or to the game manager.

5. The gaming platform of claim 1, wherein the one or more components are NVRAM, meters, bill acceptor, one or more deck buttons, or touch screen.

6. A gaming platform for a gaming machine, comprising:
an operating system program including data for basic core functions of a gaming machine;
a game application program including game-specific non-shared executable objects, paytable data, graphics, and sounds, wherein the game application program is separate from the operating system program, and wherein the game application program drives the operation of a game;
a testing program in communication with the game manager, wherein the testing program communicates with an external test client to determine operability of one or more components within the gaming machine; and
a game manager interface in communication with the game application program and the operating system program, wherein the game manager interface facilitates the functions called by the game application program and carried out by the operating system program.

7. The gaming platform of claim 6, further comprising a sound server having sound files that are in communication with the game manager interface, wherein the sound server receives requests for and sends sound files to the game manager interface for execution on the gaming machine.

8. The gaming platform of claim 6, further comprising a video server in communication with the game manager interface, wherein the video server receives requests for and sends graphic files and fonts to the game manager interface for execution on the gaming machine.

9. The gaming platform of claim 6, wherein the one or more components are NVRAM, meters, bill acceptor, one or more deck buttons, or touch screen.
